(19) United States
(12) Patent Application Publication
(10) Pub. No.: US 2007/0110111 A1
(43) Pub. Date: May 17, 2007

(54) Power system for ultraviolet lighting

(76) Inventors: David D. Shipp, Murrysville, PA (US); Richard S. Pietryka, Columbia, MD (US); Daniel J. Carnovale, Gibsonia, PA (US); Kanaiyalal R. Shah, North Potomac, MD (US); Michael J. Kociolek SR., Severn, MD (US)

Correspondence Address: MARTIN J. MORAN, ESQ.;Eaton Electrical, Inc., Technology & Quality Center, 170 Industry Drive, RIDC Park West, Pittsburgh, PA, 15275-1032, US

(21) Appl. No.: 11/273,631

(22) Filed: Nov. 14, 2005

(51) Int. Cl. H01S 3/13

(52) U.S. Cl. 372/29.021

(57) ABSTRACT

A power system for ultraviolet lighting includes a first network transformer structured to be powered from a first medium voltage power source and to output a first low voltage output; and a second network transformer structured to be powered from a second medium voltage power source and to output a second low voltage output. A first network protector inputs the first low voltage output of the first network transformer and outputs a third output. A second network protector inputs the second low voltage output of the second network transformer and outputs a fourth output. A spot network is powered from the third output of the first network protector and from the fourth output of the second network protector. A number of sag ride thru devices include an input powered from the spot network and an output structured to power a number of ultraviolet lights.

### BACKGROUND OF THE INVENTION

1. Field of the Invention

This invention pertains generally to power systems and, more particularly, to power systems for ultraviolet lighting.

2. Background Information

Ultraviolet (UV) lights are effective and reliable barriers against, for example, Cryptosporidium and Giardia, which are present in almost all surface waters. These microscopic parasites are resistant to traditional water treatment methods, such as chlorination. Drinking water with these parasites, when ingested, can cause severe abdominal cramps and diarrhea.

The cost, for example, of a medium pressure (i.e., with respect to untreated water) UV system for inactivation of Cryptosporidium and Giardia is about $0.05 per 1000 gallons of untreated water as compared to about $0.75 per 1000 gallons for a membrane system and about $0.20 per 1000 gallons for an ozonation system. However, an ozonation system is not as effective as a UV system or a membrane system. Thus, in terms of both cost and effectiveness, the UV system is clearly preferred.

Other than UV lights, there are no known alternative electric lights that may be employed to inactivate Cryptosporidium and Giardia.

FIG. 1 shows a simplified view of a typical UV disinfection process 2 of a water treatment system 3 for treating, for example, raw water 4 from a river, lake, water reservoir or other untreated water source. The UV disinfection process 2 may include a number of parallel processes 6,8,10, which can be added or removed based upon the desired volume of the raw water 4 to be treated. The various series steps of these parallel processes 6,8,10 include rapid mix 12, flocculation 14, sedimentation basins 16, filters 18, pumps 20 and UV lights 22. In turn, the outputs of the parallel processes 6,8,10 are collected by a number of finished water reservoirs 24. As a non-limiting example, the various UV lights 22 may include, for example, about 2 to about 20 sets of UV lights.

UV lights (e.g., UV lamps) have a known problem when employed as part of a UV disinfection process. When turned on to start the UV disinfection process, UV lights typically take about five minutes to reach full capacity for medium pressure UV systems. Also, after the UV lights are shut down (e.g., due to power sags or power outages), it may take the UV lights between about two minutes to about five minutes to cool down. Hence, after the UV lights are shut off, it will take between about five minutes to about ten minutes between the shutdown time of a set of UV lights to the time where the UV lights could be re-ignited again, and between about seven minutes to about ten minutes for the UV lights to reach full output capacity. Hence, in order to provide a continuous UV disinfection process, in which the finished water output need not be discarded or retreated, it is imperative that a reliable and continuous supply of power be provided to the UV lights.

The only known prior proposal of a reliable and continuous power supply for the UV lights of a UV disinfection process is an uninterruptible power supply (UPS)/battery system 26 as shown in FIG. 2. The UPS/battery system 26 powers the UV lights 28,30 of a UV disinfection process and includes about five minutes to about 15 minutes of battery storage for power sags or power outages. The UPS/battery system 26 includes two medium voltage (MV) power source feeders 32,34, which power two medium-to-low voltage transformers 36,38, respectively. There are two normally closed (NC) drawout circuit breakers 40,42 and one normally open (NO) drawout circuit breaker 44 downstream of the transformers 36,38. All three circuit breakers 40,42,44 are key interlocked as indicated by the two keys (K) 46 operatively associated with at most two of the three circuit breakers 40,42,44. Each of the circuit breakers 40,42,44 can only be closed when one of the keys 46 is inserted. Only two keys 46 are available. Hence, only two of the three circuit breakers 40,42,44 can be closed at one time. For example, during normal operation, the two NC main circuit breakers 40,42 are closed and the tie NO circuit breaker 44 will remain open. When one of the two feeders 32,34 is without power, and as a result the corresponding one of the circuit breakers 40,42 is open (e.g., in response to an under voltage relay (not shown) either built into the circuit breaker or required by the power company when there is on-site generation in order to prevent the generator from backfeeding the utility), the operator will remove the key 46 from the open circuit breaker (e.g., the circuit breaker 40 connected to the feeder 32 with no power) and insert it in the tie NO circuit breaker 44 (e.g., which was previously open), in order to close it to provide normal alternating current power to the UPS 48 (e.g., which was without power when the main circuit breaker 40 opened due to loss of power from the feeder 32). Because of the batteries 74,76 in the system 26, the UV lamps 28,30 receive continuous power.

Two NC feeder circuit breakers 50,52 are upstream of respective UPSs 48,54. These feeder circuit breakers 50,52 are normally closed, in order to provide power to the respective UPSs 48,54. A circuit breaker, such as 50 or 52, on the line side (upstream of the corresponding one of the UPSs 48 or 54) is required to open the corresponding one of the UPS feeder lines 56 or 58, respectively, for: (1) a fault in the corresponding one of the UPSs; or (2) a fault downstream of the corresponding UPS.

Two NC drawout circuit breakers 60,62 and one NO tie drawout circuit breaker 64 downstream of the UPSs 48,54 also employ a key interlock. When one of the UPSs 48,54 is unavailable due to maintenance or repair or a fault, then the other one of the UPSs 54,48 will provide power to the UV lamps 28,30 by the operator closing the tie NO circuit breaker 64 with the key 66.

The NO UPS by-passes 66,68 are used only when the respective UPSs 48,54 are undergoing repair or maintenance. When the NO UPS by-pass, such as 66, is closed, it by-passes the UPS 48. As a result, under this condition, power to the UV lamps 28 or 30 will be “raw” power from the UPS feeder lines 56 or 58 and, thus from the MV power source feeders 32 or 34 (e.g., plant power source; utility power source) with typical unconditioned sags, which may result in the shutdown of the UV lamps 28 or 30. The power control cabinets 70,72, which provide a suitable higher voltage, power the plural UV lamps 28,30, respectively.

The UPS/battery system 26 requires suitable UPSs 48,54 plus a suitably sized building (not shown) for storage of the UPS batteries 74,76. The cost of the building, and the operation and maintenance costs of the UPS/battery system 26, which depend upon the requirements of the UV lamps 28,30, are substantial.

A network protector is a special circuit breaker adapted to trip and open a power source, such as a feeder, upon detection of reverse power flow (i.e., power flowing through the power source and out of a network rather than into the network, or, in other words, power flow from the loads toward the networked source). The network protector also includes a control relay, which senses transformer voltages, network voltages and line currents, and executes algorithms to initiate breaker tripping or reclosing action. Trip determination is based on detecting reverse power flow. Examples of network protectors are disclosed in U.S. Pat. Nos. 6,459,554; 5,822,165; and 3,947,728, which are incorporated by reference herein. Examples of network protector relays are disclosed in U.S. Pat. Nos. 6,671,151; 5,844,781; 5,822,165; and 3,947,728.

Distribution networks are a type of electrical power distribution system used by utilities and relatively large industrial users to provide highly reliable power by connecting multiple sources of power supply to a common load. Because of the multiple sources, a malfunction of one or more power sources can often be tolerated without impact on the loads. To manage such multiple-source networks, the provision for safe and fully automatic connection of healthy power sources and disconnection of faulty power sources is necessary. Network protectors provide this provision automatically. The overriding goal of a network system including plural network protectors is to electrically connect as many power sources as possible, thereby improving redundancy and, therefore, the reliability of the power sources.

There is room for improvement in power systems for ultraviolet lighting.

### SUMMARY OF THE INVENTION

This need and others are met by the present invention, which provides a power system for ultraviolet lighting in which a number of sag ride thru devices include an input powered from a spot network or from one or more busses and an output structured to power a number of ultraviolet lights.

In accordance with one aspect of the invention, a power system for ultraviolet lighting comprises: a first network transformer structured to be powered from a first power source and to output a first output; a second network transformer structured to be powered from a second power source and to output a second output; a first network protector inputting the first output of the first network transformer and outputting a third output; a second network protector inputting the second output of the second network transformer and outputting a fourth output; a spot network powered from the third output of the first network protector and from the fourth output of the second network protector; and a number of sag ride thru devices including an input powered from the spot network and an output structured to power a number of ultraviolet lights.

The first and second power sources may be medium voltage power sources, and the first and second outputs may be low voltage outputs.

The first and second network transformers may include a delta/wye configuration having a delta primary winding structured to be powered from a corresponding one of the first and second power sources and a wye secondary winding outputting a corresponding one of the first and second outputs.

The first and second network transformers may include a wye secondary having a central node and a high resistance grounding unit grounding the central node.

Each of the first and second network protectors may comprise a network relay, a circuit breaker controlled by the network relay and an arc flash reduction maintenance switch for the circuit breaker.

The input of the sag ride thru devices may include a transient voltage surge suppression device.

As another aspect of the invention, a power system for ultraviolet lighting comprises: a sub-cycle transfer switch comprising a first input structured to receive a first power source, a second input structured to receive a second power source, and an output powered from one of the first and second inputs; a first transformer including a first output and an input powered from the output of the sub-cycle transfer switch; a second transformer including a second output and an input powered from the output of the sub-cycle transfer switch; a first sag ride thru device including an input powered from the first output of the first transformer and an output structured to power a number of ultraviolet lights; and a second sag ride thru device including an input powered from the second output of the second transformer and an output structured to power a number of ultraviolet lights.

As another aspect of the invention, a power system for powering ultraviolet lighting from a plurality of power sources comprises: at least one bus; and a number of sag ride thru devices including an input and an output, the number of sag ride thru devices being structured to be: (a) powered at the input from the at least one bus and to power from the output a number of ultraviolet lights, or (b) powered at the input from one of the power sources and to power from the output the at least one bus which, in turn, powers a number of ultraviolet lights.

As another aspect of the invention, a power system for ultraviolet lighting comprises: a first sag ride thru device including an input structured to receive a first power source and an output; a second sag ride thru device including an input structured to receive a second power source and an output; a sub-cycle transfer switch comprising a first input powered from the output of the first sag ride thru device, a second input powered from the output of the second sag ride thru device, and an output powered from one of the first and second inputs; and at least one transformer including an input powered from the output of the sub-cycle transfer switch and an output structured to power a number of ultraviolet lights.

As another aspect of the invention, a power system for ultraviolet lighting comprises: a first sag ride thru device including an input structured to receive a first power source and an output; a second sag ride thru device including an input structured to receive a second power source and an output; a first transformer powered from the output of the first sag ride thru device, the first transformer outputting a first output; a second transformer powered from the output of the second sag ride thru device, the second transformer outputting a second output; a first circuit interrupter inputting the first output of the first transformer and outputting a third output; a second circuit interrupter inputting the second output of the second transformer and outputting a fourth output; and a normally open tie circuit interrupter electrically connected between the third output of the first circuit interrupter and the fourth output of the second circuit interrupter, wherein the third output of the first circuit interrupter is structured to power a number of ultraviolet lights, and wherein the fourth output of the second circuit interrupter is structured to power a number of ultraviolet lights.

As another aspect of the invention, a power system for ultraviolet lighting comprises: a first transformer structured to be powered from a first power source and to output a first output; a second transformer structured to be powered from a second power source and to output a second output; a first circuit interrupter inputting the first output of the first transformer and outputting a third output; a second circuit interrupter inputting the second output of the second transformer and outputting a fourth output; a normally open tie circuit interrupter electrically connected between the third output of the first circuit interrupter and the fourth output of the second circuit interrupter; a first sag ride thru device including an input powered from the third output of the first circuit interrupter and an output structured to power a number of ultraviolet lights; and a second sag ride thru device including an input powered from the fourth output of the second circuit interrupter and an output structured to power a number of ultraviolet lights.

As another aspect of the invention, a low voltage power system for ultraviolet lighting comprises: a first normally closed circuit interrupter structured to receive a low voltage power source and output a first output responsive to predetermined voltage and forward power flow conditions; a second normally closed circuit interrupter structured to receive a low voltage power source and output a second output responsive to predetermined voltage and forward power flow conditions; a tie circuit interrupter electrically connected between the first output of the first circuit interrupter and the second output of the second circuit interrupter; and at least one sag ride thru device including an input powered from one or both of the first and second outputs and an output structured to power a number of ultraviolet lights.

### BRIEF DESCRIPTION OF THE DRAWINGS

A full understanding of the invention can be gained from the following description of the preferred embodiments when read in conjunction with the accompanying drawings in which:

FIG. 1 is a simplified block diagram of a typical ultraviolet (UV) disinfection process of a water treatment system for treating raw water.

FIG. 2 is a block diagram of an uninterruptible power supply (UPS)/battery system for powering the UV lights of a UV disinfection process.

FIG. 3 is a block diagram of a power system for UV lighting in accordance with the present invention.

FIGS. 4-10 are block diagrams of power systems for UV lighting in accordance with other embodiments of the invention.

### DESCRIPTION OF THE PREFERRED EMBODIMENTS

As employed herein, the term “number” shall mean one or an integer greater than one (i.e., a plurality).

The present invention is described in association with power systems for ultraviolet (UV) lights of a UV disinfection process, although the invention is applicable to a wide range of power supplies for UV lights.

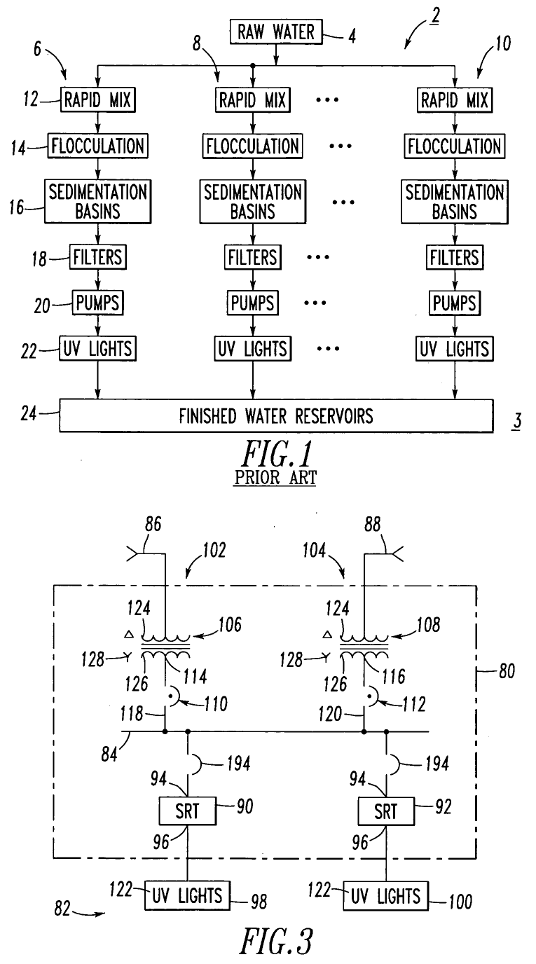

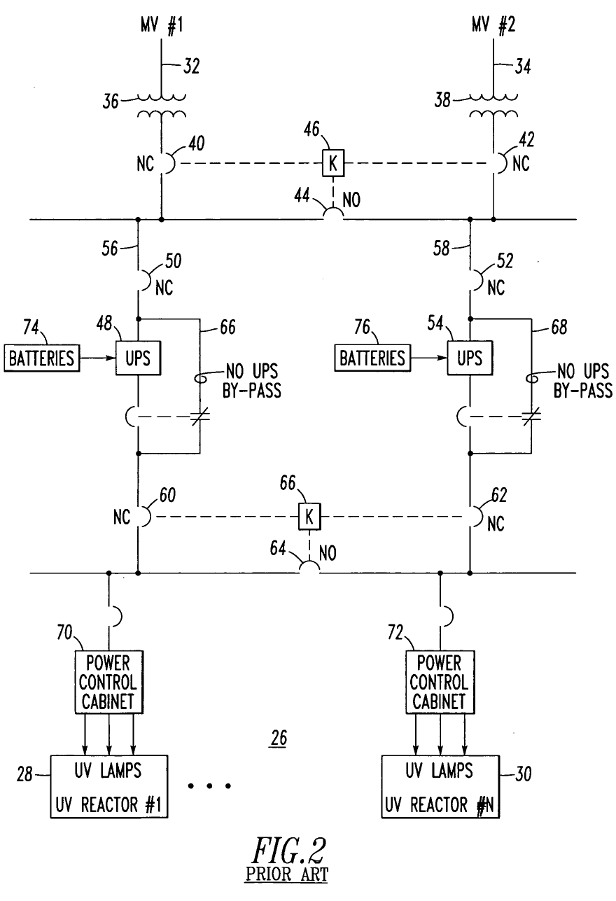

Referring to FIG. 3, a power system 80 for ultraviolet lighting 82 includes a bus, such as a spot network 84, powered from a plurality of power sources, such as for example medium voltage (MV) feeders 86,88, and one or more sag ride thru (SRT) devices, such as 90,92. The SRT devices 90,92 include an input 94 powered from the spot network 84 and an output 96 structured to power a number of ultraviolet lights, such as 98 or 100.

### Example 1

In this example, the spot network 84 powers two SRT devices 90,92, although three of more SRT devices may be employed. Also, the spot network 84 is powered from two feeder systems 102,104, although three or more feeder systems may be employed. Each of the example feeder systems 102,104 includes a network transformer, 106 or 108, and a network protector, 110 or 112. The first network transformer 106 is structured to be powered from the first MV feeder 86 and to output a first output 114. The second network transformer 108 is structured to be powered from the second MV feeder 88 and to output a second output 116. The first network protector 110 inputs the first output 114 of the first network transformer 106 and outputs a third output 118. The second network protector 112 inputs the second output 116 of the second network transformer 108 and outputs a fourth output 120. In turn, the spot network 84 is powered from the third and fourth outputs 118,120, and powers the example SRT devices 90,92.

### Example 2

The power sources, such as the example MV feeders 86,88, are MV power sources, and the first and second outputs 114,116 are low voltage outputs. In turn, the UV lights 98,100 are powered from a suitable low voltage (e.g., without limitation, less than about 1 kVAC; about 480 VAC (US); about 380 VAC (Europe); about 600 VAC (Canada); any suitable low voltage). The inputs to the UV lights 98,100 are transformed to a relatively higher voltage through a suitable type of ballast transformer/electronics (not shown) with the actual individual UV lamps 122 being powered at a relatively much higher voltage (e.g., a suitable voltage determined by the manufacturer of the UV lights 98,100).

### Example 3

As employed herein, the term “network” refers to a low voltage power system including a plurality of power sources wherein the design criterion is to maintain network power with a relatively very high reliability. For example, a typical network includes about four to about eight (not shown) interconnected transformer sources. Each transformer source includes a network protector, such as 110 or 112, which does not trip into the forward direction (in which power flows through the transformer to the network load), but which does trip relatively very quickly if reverse power flows from the network load to the transformer. A “spot network,” such as 84, is a relatively smaller network in which there are about two or about three or more transformers connected to a common bus. A typical application is a utility vault (not shown) on a floor of a high-rise building (not shown) or in a water treatment room (not shown). In contrast, a full network has its transformers remotely located from each other.

### Example 4

An example of the SRT devices 90,92 (e.g., a sag corrector) is a Sag Ride Through (SRT) product or Sag Corrector product marketed by the Power Quality Solutions Organization (PQSO) of Eaton Electrical, Inc. of Moon Township, Pa.

### Example 5

The example SRT devices 90,92 include a voltage source inverter, a bypass circuit and an injection transformer electrically connected in series between an incoming utility supply, such as outputs 114 or 116, and a load, such as the UV lights 98 or 100. The SRT devices are high performance, inverter-based active voltage conditioning devices that provide protection to sensitive loads against commonly occurring voltage sags. The SRT device monitors the incoming supply voltage and when it deviates from the nominal voltage level, the SRT device achieves voltage conditioning by injecting the appropriate correction voltage in series with the power supply. The SRT device provides an extremely fast reaction time and sub-cycle response to sag events that would otherwise cause loads to drop out.

For example, without limitation, the example SRT device is used to provide continuous power to UV systems under conditions that would otherwise cause the UV system to “shut off”. For example, for a voltage sag of 50% at the input to the SRT device, the output of the SRT device will be regulated above the critical required input voltage that will allow the UV lighting to continue to operate. For this same voltage sag of 50%, without the SRT device, the UV system would “shut off”.

### Example 6

The example SRT devices 90,92 correct relatively deep sags in a suitable sub-cycle time. For example, without limitation, input line voltages of about −63%, including phase shifts and distortion, are corrected using a series compensation transformer with dual-conversion voltage injection.

### Example 7

Although FIG. 3 shows two SRT devices 90,92 and two sets of UV lights 98,100, there may be one or more SRT devices and one or more sets of UV lights (e.g., without limitation, six SRT devices and 6-18 sets of UV lights; a variable design function of the design engineer) for each SRT device. For example, a relatively small SRT device may supply one set of UV lights on one treatment reactor (not shown). However, a relatively more cost effective approach is to supply one relatively larger SRT device and feed several UV units (e.g., each UV unit having several individual UV lights, which are all controlled as one unit by the UV manufacturer). Each UV unit includes one or more UV lamp banks each of which is comprised of plural UV lamps and suitable controls to control the brilliance of the UV lamps. If, for example, one of the UV lamps in one of the UV lamp banks fails, then the controls shut-off the affected lamp bank and increase the brilliance of the remaining lamps to maintain the brilliance requirements. If the remaining UV lamps cannot sustain an acceptable level of intensity, then the controls turn them off and direct the untreated water (e.g., the output of the pumps 20 of FIG. 1) to prevent untreated water from being pumped into the water supply (e.g., finished water reservoirs 24 of FIG. 1).

### Example 8

As another example, the UV lights are grouped in sets of three or more. The untreated water flows through a reactor (not shown) at right angles to the UV lights. If a single UV lamp goes out (e.g., as a result of a single phase voltage sag), then a monitoring system (not shown) detects the loss of a UV lamp and the system reports the failure. In this example, even if there may be two other active UV lamps, the system cannot take “credit” for “treating” the untreated water since at least one UV lamp is out. The single phase response and the design of the SRT devices 90,92 allow for treatment of a single phase event, two phase events or three phase events, in order that the SRT devices are matched well with this concern.

### Example 9

For redundancy, there may be two or more SRT devices, such as 90,92, and two or more sets of UV lights, such as 98,100, such that if any SRT device or any UV light fails, then the system continues to function.

### Example 10

As another alternative, there may be, for example, one SRT device for the ultraviolet lighting 82 or one SRT device for plural UV lighting systems.

### Example 11

The input MV alternating current (AC) from the feeders 86,88 may be any suitable MV (e.g., without limitation, between about 2.4 kVAC and about 75 kVAC).

### Example 12

Non-limiting examples of the network protectors 110,112 are model numbers CM52, CMD or CM-22 marketed by Eaton Electrical, Inc. of Pittsburgh, Pa.

### Example 13

The example three-phase network transformers 106,108 include a delta/wye configuration having a delta primary winding 124 structured to be powered from a corresponding one of the feeders 86,88 and a wye secondary winding 126 outputting a corresponding one of the first and second outputs 114,116. The wye secondary winding 126 has a central node (e.g., neutral or wye point) 128 which is: (a) grounded through a high resistance grounding unit 130 (FIG. 5); (b) directly electrically connected to ground 132 (i.e., solidly-grounded (not shown)); or (c) ungrounded. Alternatively, the network transformers 106,108 may include a delta connected secondary winding (not shown).

Statistically, most faults that occur are single line-to-ground faults (e.g., one phase to ground) in which one of the three-phase conductors shorts to ground (e.g., a metal cabinet; a conduit; a ground rod). If the neutral point 128 is solidly tied to ground, then the most common ground fault will allow very high currents to flow. Hence, the circuit must be tripped off line, in order to reduce the risk of catastrophic failure. However, if that neutral point 128 to ground is electrically connected through a relatively high ohmic resistor, then this resistor will limit the current to an extremely low value (e.g., typically under 5 A). In this example, the power system 136 (FIG. 5) continues to operate without catastrophic failure and, thus, does not have to open any protective device in order to clear the fault. This provides much better continuity of service.

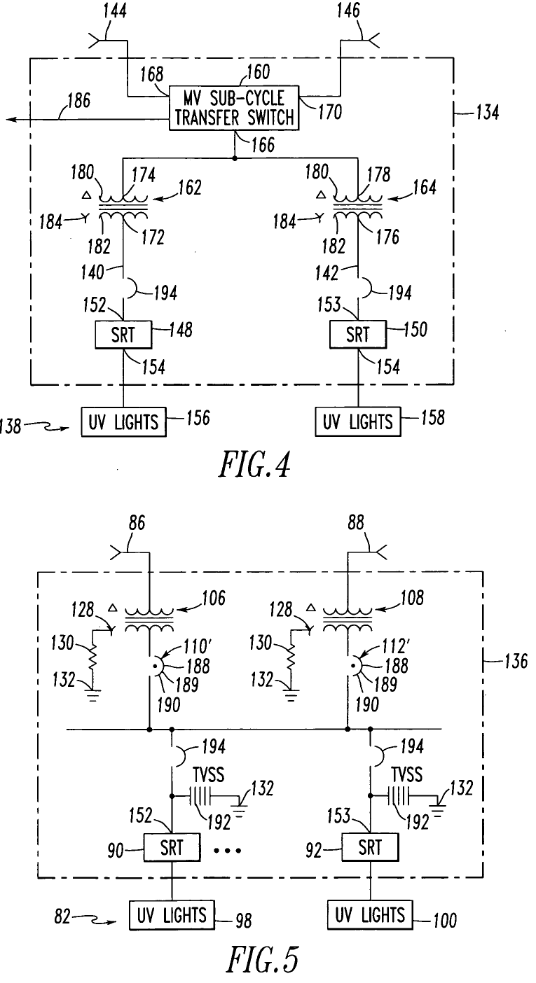

FIGS. 4 and 5 are examples of other power systems 134 and 136, respectively, for UV lighting. In FIG. 4, the power system 134 for ultraviolet lighting 138 includes two busses, such as power busses or feeders 140,142, powered from a plurality of power sources, such as MV feeders 144,146, and one or more SRT devices, such as 148,150. The SRT devices 148,150 include respective inputs 152,153 powered from one of the corresponding power busses or feeders 140,142, and an output 154 structured to power a number of ultraviolet lights, such as 156 or 158.

### Example 14

The example power system 134 of FIG. 4 includes a MV sub-cycle transfer switch 160 and two or more transformers, such as secondary unit substation type transformers 162,164. The output 166 of the transfer switch 160 is electrically connected to transformers 162,164, which power the respective SRT devices 148,150. The transfer switch 160 and the transformers 162,164 replace the network transformers 106,108 and network protectors 110,112 of FIG. 3.

The sub-cycle transfer switch 160 includes a first input 168 structured to receive the first MV feeder 144, a second input 170 structured to receive the second MV feeder 146, and an output 166 powered from one of the first and second inputs 168,170. The first transformer 162 includes a first output 172 and an input 174 powered from the transfer switch output 166. The second transformer 164 includes a second output 176 and an input 178 powered from the transfer switch output 166. The first SRT device input 152 is powered from the first output 172 of the first transformer 162. The second SRT device input 153 is powered from the second output 176 of the second transformer 164.

The configuration of the count of SRT devices, such as 148 and/or 150, and the count of UV lights, such as 156 and/or 158, may be the same as was described above in connection with the different examples of one or more SRT devices 90,92 and UV lights 98,100 of FIG. 3.

### Example 15

The first and second power sources are MV feeders 144,146, and the first and second SRT devices 148,150 are low voltage SRT devices.

### Example 16

The three-phase first and second transformers 162,164 include a delta/wye configuration having a delta primary winding 180 powered from the transfer switch output 166 and a wye secondary winding 182 outputting a corresponding one of the first and second outputs 172,176. The wye secondary winding 182 has a central node (e.g., neutral or wye point) 184 which is: (a) grounded through a high resistance grounding unit 130 (FIG. 5); (b) directly electrically connected to ground 132 (FIG. 5); or (c) ungrounded.

### Example 17

An example of the MV sub-cycle transfer switch 160 is model MVSTS marketed by Eaton Electrical, Inc. of Greenwood, S.C. Here, sub-cycle means, for example, that the transfer switch 160 senses loss of power and quickly transfers from a normal power source (e.g., MV feeder 144) to an alternate power source (e.g., MV feeder 146) and does so in less than one cycle (e.g., less than about 1/60 second for an example 60 Hz power source). As such, the load will never know that the transfer switch 160 has transferred its output 166 from the normal power source to the alternate power source.

### Example 18

A plurality of pumps (e.g., pumps 20 of FIG. 1) may be operatively associated with the ultraviolet lighting 138. The sub-cycle transfer switch 160 includes an output 186 structured to disable the pumps upon loss of both of the first and second MV feeders 144,146.

### Example 19

The output 186 which shuts down the pump(s) (e.g., pumps 20 of FIG. 1) is not required in the power system 80 of FIG. 3 if a sufficient number of feeder systems 102,104 are provided, thereby increasing reliability of the spot network 84.

### Example 20

The power system 136 of FIG. 5 is somewhat similar to the power system 80 of FIG. 3. Here, the example high resistance grounding unit 130 is a type C-HRG unit, model number F4WNDNNSF, marketed by Eaton Electrical, Inc. of Asheville, N.C.

### Example 21

Alternatively, if the C-HRG type of grounding is not employed, then the power system may be solidly grounded, but may be subject to damage and/or tripping when there is a single line to ground fault.

### Example 22

Alternatively, if the C-HRG type of grounding is not employed, and the power system is completely ungrounded, then in response to a ground fault, the voltage can escalate and result in insulation failure and/or other significant damage.

### Example 23

In FIG. 5, the circuit breaker 188 of the network protectors 110′,112′ includes an optional Arc flash Reduction Maintenance Switch (ARMS) 189, which is marketed by Eaton Electrical, Inc. of Greenwood, S.C. The network protectors 110′,112′ also include a network relay 190, which controls the circuit breaker 188.

### Example 24

An example of an arc flash reduction maintenance switch is disclosed by U.S. patent application Publication No. 2005/0219775, which is incorporated herein by reference. The maintenance switch, such as 189, which includes a normal position to select a specified trip function of the circuit breaker 188 and a maintenance position to select a maintenance trip function, overrides the specified trip function with the maintenance trip function. This results in reduced arc energy in a fault during a trip with the maintenance trip function as compared to arc energy during a trip with the specified trip function.

### Example 25

The example UV lighting power system 136 includes a number of high power devices. Hence, there is a relatively very high available arc flash energy. If, for example, a worker might cause an arc flash incident, then the energy would be relatively high. As such, the worker would have to wear relatively excessive personal protective equipment since the worker can cause the fault and be exposed to a dangerous situation. The ARMS function of the ARMS 189 allows the worker to significantly reduce the risk and exposure to arc flash incidents. As such, most of the time, the worker does not have to wear the relatively excessive personal protective equipment.

### Example 26

Alternatively, if the ARMS function is not employed, then the worker should always work on the equipment with the extra personal protective equipment in view of increased safety concerns and/or risks.

### Example 27

The power system 136 of FIG. 5 includes optional transient voltage surge suppressers (TVSSs) 192, such as example Clipper models, such as CPS250480DSG, at the inputs 152,153 of the respective SRT devices 90,92. The Clipper Power System (CPS), 250 kA surge protector, rated for a delta connected power system would be applied (if using the high resistance grounding unit 130 of FIG. 5) because the line-to-ground voltage may approach the line-to-line voltage during a ground fault condition which would fail the MOVs in the surge protector. Alternatively, a wye rated surge protector would be used on a solidly grounded power system. The example CPS is marketed by Eaton Electrical, Inc. of Calgary, Canada. The TVSS 192 is essentially a very special low voltage lightning arrester designed to protect electronic loads. The TVSS typically has six elements inside (e.g., three elements connected phase-to-ground, and three elements connected phase-to-phase with other variations available).

### Example 28

If the TVSSs 192 are not employed, and if a transient voltage travels into the power system 136, then there is the high risk of failing the electronics of the SRT devices 90,92.

### Example 29

Each of the SRT devices 90,92,148,150 of FIGS. 3-5 preferably includes a suitable upstream circuit interrupter 194 (e.g., circuit breaker; fused switch).

### Example 30

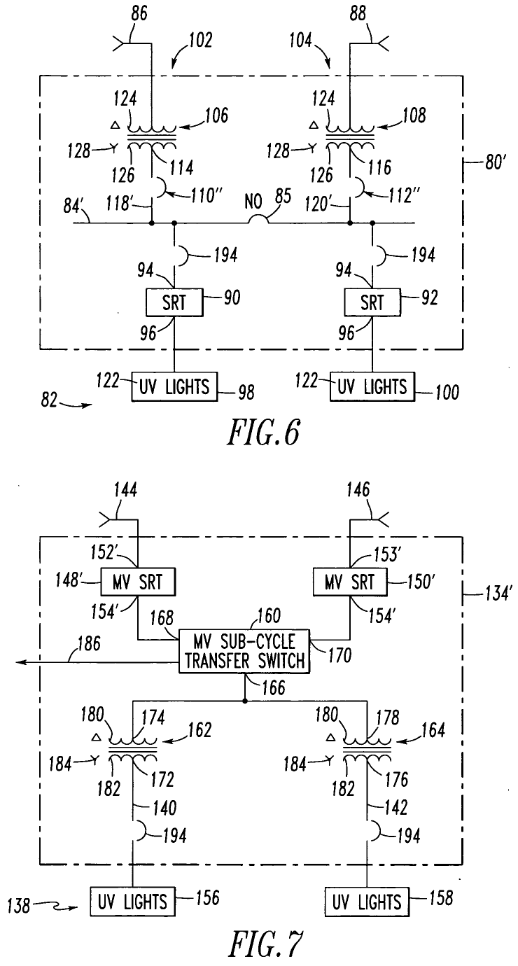

Referring to FIG. 6, a power system 80′ for ultraviolet lighting 82 includes a bus 84′ powered from a plurality of power sources, such as, for example, MV feeders 86,88, and one or more SRT devices, such as 90,92. The power system 80′ is the same as the power system 80 of FIG. 3, with two exceptions. First, the networks protectors 110,112 of FIG. 3 are replaced by suitable circuit interrupters, such as draw-out circuit breakers 110″,112″, respectively. Second, the spot network 84 of FIG. 3 is replaced by a bus 84′ in which a normally open tie circuit interrupter (e.g., without limitation, tie switch; tie circuit breaker; tie fused switch) 85 is electrically connected between the circuit interrupter outputs 118′,120′. This main-tie-main arrangement allows the UV lights 98,100 on one system to be fed from either of the transformers 106,108.

### Example 31

FIG. 7 shows a power system 134′ for ultraviolet lighting 138. The power system 134′ is similar to the power system 134 of FIG. 4 except that the low voltage SRT devices 148,150 are eliminated and suitable medium voltage (MV) SRT devices 148′,150′ are disposed upstream of the inputs 168,170 of the MV sub-cycle transfer switch 160. In particular, the input 152′ of the first MV SRT device 148′ is structured to receive the first MV feeder 144, and the input 153′ of the second MV SRT device 150′ is structured to receive the second MV feeder 146. The first input 168 of the MV sub-cycle transfer switch 160 is powered from the output 154′ of the first MV SRT device 148′, and the second input 170 of the MV sub-cycle transfer switch 160 is powered from the output 154′ of the second MV SRT device 150′. The first output 172 of the first transformer 162 is structured to power a number of ultraviolet lights 156, and the second output 176 of the second transformer 164 is structured to power a number of ultraviolet lights 158.

### Example 32

FIG. 8 shows a power system 80″ for ultraviolet lighting 82. The power system 80″ is similar to the power system 80′ of FIG. 6 except that the low voltage SRT devices 90,92 are eliminated and suitable medium voltage (MV) SRT devices 90′,92′ are disposed upstream of the transformers 106,108. In particular, the input 94′ of the first MV SRT device 90′ is structured to receive the first MV feeder 86, and the input 94′ of the second MV SRT device 92′ is structured to receive the second MV feeder 88. The primary winding 124 of the first transformer 106 is powered from the output 96′ of the first MV SRT device 90′, and the primary winding 124 of the second transformer 108 is powered from the output 96′ of the second MV SRT device 92′. Similar to FIG. 6, the normally open tie circuit interrupter (e.g., without limitation, tie switch; tie circuit breaker; tie fused switch) 85 is electrically connected between the circuit interrupter outputs 118′,120′. This allows the MV SRT devices 90′,92′ to supply power to the transformers 106,108, which, in turn, power the UV lighting 82. The main-tie-main arrangement allows the UV lights 98,100 on one system to be fed from either of the transformers 106,108.

### Example 33

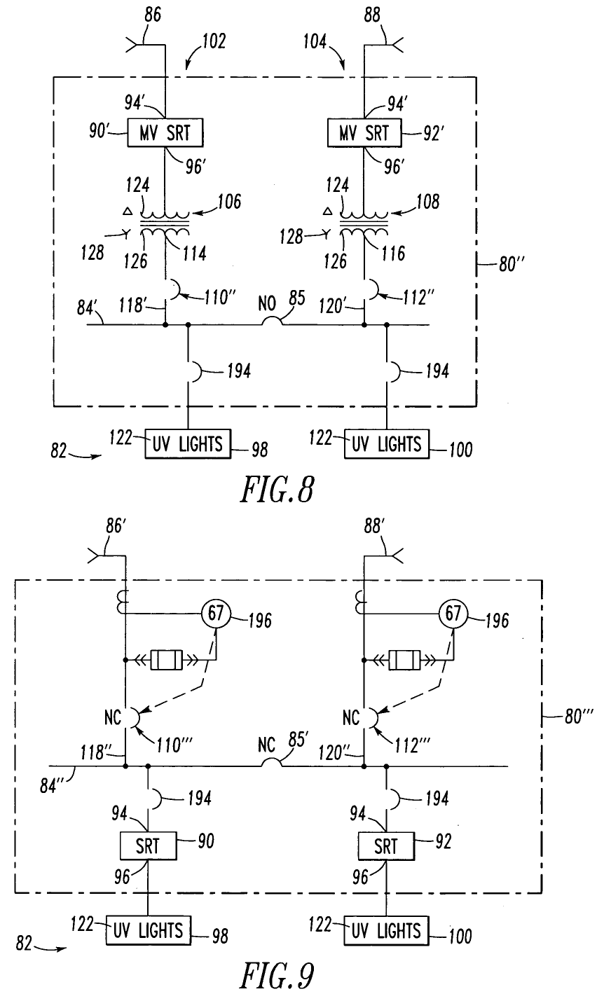

Referring to FIG. 9, a low voltage power system 80′″ for ultraviolet lighting 82 includes a bus 84″ powered from a plurality of power sources, such as, for example, low voltage feeders 86′,88′, and one or more SRT devices, such as 90,92. The power system 80′″ may be employed where there is no available MV power and the UV lighting system requirements are less than about 500 kVA. The power system 80′″ is the same as the power system 80′ of FIG. 6, with three exceptions. First, the transformers 106,108 of FIG. 6 are eliminated since the low voltage feeders 86′,88′ are used in place of the MV feeders 86,88. Second, the circuit interrupters 110″,112″ are replaced by respective normally closed (NC) circuit interrupters 110′″,112′″, as will be described. Third, a normally closed (NC) tie circuit interrupter 85′ is electrically connected between the circuit interrupter outputs 118″,120″. This arrangement allows the UV lights 98,100 on one system to be fed from either or both of the low voltage feeders 86′,88′. Otherwise, from the bus 84″, the power supply to the SRT devices 90,92 and the ultraviolet lighting 82 is the same as in the medium voltage power system 80′ of FIG. 6.

Operation of the low voltage power system 80′″ is as follows. The low voltage feeders 86′,88′ (e.g., less than or equal to about 600 VAC) feed the low voltage NC circuit interrupters 110′″,112′″. The bus 84″ receives power from both of the two low voltage feeders 86′,88′ through the NC circuit interrupters 110′″,112′″ when the NC tie circuit interrupter 85′ is closed. When one of the low voltage feeders 86′,88′ is unavailable or faulted, a corresponding reverse current relay (“67”) 196 opens the corresponding circuit interrupter 110′″ or 112′″ connected to the unavailable or faulted feeder. The NC circuit interrupters 194 feed the SRT devices 90,92 and, thus, the ultraviolet lighting 82. Since the tie circuit interrupter 85′ is normally closed, power to the bus 84″ and, hence, to the SRT devices 90,92 and ultraviolet lighting 82 is maintained (i.e., without any interruption).

It is believed that the structure of the power system 80′″ is reliably applicable to only two low voltage power sources, such as 86′,88′.

### Example 34

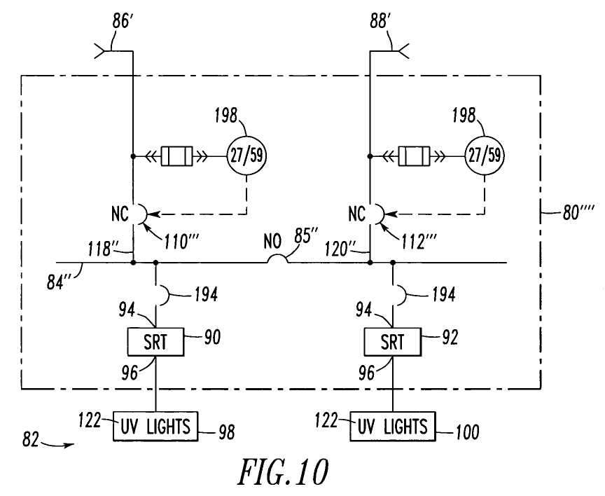

Referring to FIG. 10, a low voltage power system 80″″ for ultraviolet lighting 82 includes a bus 84″ powered from a plurality of power sources, such as, for example, low voltage feeders 86′,88′, and one or more SRT devices, such as 90,92. The power system 80″″ is the same as the power system 80′″ of FIG. 9, with three exceptions. First, the normally closed (NC) tie circuit interrupter 85′ is replaced by a normally open (NO) tie circuit interrupter 85″. Second, the reverse current relays (“67”) 196 are not employed. Third, under/over voltage relays (“27/59”) 198 are employed. A corresponding under voltage condition (e.g., loss of source) is detected by the “27” relay function, which causes its corresponding main circuit interrupter to open and the NO tie circuit interrupter 85″ to close. Upon restoration of power, the “59” relay function may optionally initiate an automatic transfer back to the original circuit conditions.

This arrangement allows the UV lights 98,100 on one system to be fed from either or both of the low voltage feeders 86′,88′. Otherwise, from the bus 84″, the power supply to the SRT devices 90,92 and the ultraviolet lighting 82 is the same as in the medium voltage power system 80′ of FIG. 6.

It is believed that the structure of the power system 80″″ is reliably applicable to only two low voltage power sources, such as 86′,88′.

The disclosed power systems 80,80′,80″,80′″,80″″,134,134′,136 provide reliable power to the UV lighting 82 or 138, but at about less than one-half of the cost, at about one-half of the space, and without the maintenance problems associated with the UPS/battery system 26 of FIG. 2. For example, the SRT devices 90,92,148,150 (e.g., in the size range of 100 kW and higher) and MV sub-cycle transfer switch 160 or the network protectors 110,112,110′, 112′ have about one-half to about three quarters of the lifecycle cost of a UPS system with significantly less maintenance and electrical losses. UPS systems have several drawbacks in industrial applications because of footprint space (e.g., larger by about two times in some cases) plus UPS systems are more sensitive to heating and cooling requirements (e.g., batteries, such as 74,76 of FIG. 2, at greater than about 70° F. can lose half of their life for every increase of 10° F.). The power electronics on a UPS are essentially very similar to an SRT device, except that the SRT device generally uses more standard magnetic components (e.g., reactors; transformer; filters) and is generally in bypass until required by the load (e.g., for four or five line cycles once every few weeks). This allows the SRT device to be relatively very efficient (e.g., greater than 99%) while in a standby mode. Alternatively, the UPS units of FIG. 2 are typically about 93-96% efficient) and their losses contribute to lifecycle costs.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A power system for ultraviolet lighting, said power system comprising:
a first network transformer structured to be powered from a first power source and to output a first output;
a second network transformer structured to be powered from a second power source and to output a second output;
a first network protector inputting the first output of said first network transformer and outputting a third output;
a second network protector inputting the second output of said second network transformer and outputting a fourth output;
a spot network powered from the third output of said first network protector and from the fourth output of said second network protector; and
a number of sag ride thru devices including an input powered from said spot network and an output structured to power a number of ultraviolet lights.

2. The power system of claim 1 wherein said first and second power sources are medium voltage power sources; and wherein said first and second outputs are low voltage outputs.

3. The power system of claim 2 wherein said low voltage outputs include a voltage of less than about 1 kVAC.

4. The power system of claim 2 wherein said medium voltage power sources include a voltage of between about 2.4 kVAC and about 75 kVAC.

5. The power system of claim 1 wherein said first and second network transformers include a delta/wye configuration having a delta primary winding structured to be powered from a corresponding one of said first and second power sources and a wye secondary winding outputting a corresponding one of said first and second outputs.

6. The power system of claim 1 wherein said number of sag ride thru devices is at least one sag ride thru device; and wherein said number of ultraviolet lights is one for each of said at least one sag ride thru device.

7. The power system of claim 1 wherein said number of sag ride thru devices is at least one sag ride thru device; and wherein said number of ultraviolet lights is a plurality of said ultraviolet lights for each of said at least one sag ride thru device.

8. The power system of claim 1 wherein said number of sag ride thru devices is a plurality of said sag ride thru devices; and wherein said number of ultraviolet lights is a plurality of said ultraviolet lights for each of said sag ride thru devices.

9. The power system of claim 1 wherein said first and second network transformers include a wye secondary having a central node and a high resistance grounding unit grounding said central node.

10. The power system of claim 1 wherein said first and second network transformers include a wye secondary having a central node which is directly electrically connected to ground.

11. The power system of claim 1 wherein said first and second network transformers include a wye secondary having an ungrounded central node.

12. The power system of claim 1 wherein each of said first and second network protectors comprises a network relay, a circuit breaker controlled by said network relay and an arc flash reduction maintenance switch for said circuit breaker.

13. The power system of claim 1 wherein the input of said sag ride thru devices includes a transient voltage surge suppression device.

14. A power system for ultraviolet lighting, said power system comprising:
a sub-cycle transfer switch comprising a first input structured to receive a first power source, a second input structured to receive a second power source, and an output powered from one of said first and second inputs;
a first transformer including a first output and an input powered from the output of said sub-cycle transfer switch;
a second transformer including a second output and an input powered from the output of said sub-cycle transfer switch;
a first sag ride thru device including an input powered from the first output of said first transformer and an output structured to power a number of ultraviolet lights; and
a second sag ride thru device including an input powered from the second output of said second transformer and an output structured to power a number of ultraviolet lights.

15. The power system of claim 14 wherein a plurality of pumps are operatively associated with said ultraviolet lights; wherein the output of said sub-cycle transfer switch is a third output; and wherein said sub-cycle transfer switch further comprises a fourth output structured to disable said pumps upon loss of both of said first and second power sources.

16. The power system of claim 14 wherein said first and second power sources are medium voltage power sources; and wherein said first and second sag ride thru devices are low voltage sag ride thru devices.

17. The power system of claim 14 wherein said number of ultraviolet lights is one for each of said first and second sag ride thru devices.

18. The power system of claim 14 wherein said number of ultraviolet lights is a plurality of said ultraviolet lights for each of said first and second sag ride thru devices.

19. The power system of claim 14 wherein said number of ultraviolet lights is a plurality of said ultraviolet lights for at least one of said first and second sag ride thru devices.

20. The power system of claim 14 wherein said first and second transformers include a wye secondary having a central node and a high resistance grounding unit grounding said central node.

21. A power system for powering ultraviolet lighting from a plurality of power sources, said power system comprising:
at least one bus; and
a number of sag ride thru devices including an input and an output, said number of sag ride thru devices being structured to be: (a) powered at said input from said at least one bus and to power from said output a number of ultraviolet lights, or (b) powered at said input from one of said power sources and to power from said output said at least one bus which, in turn, powers a number of ultraviolet lights.

22. A power system for ultraviolet lighting, said power system comprising:
a first sag ride thru device including an input structured to receive a first power source and an output;
a second sag ride thru device including an input structured to receive a second power source and an output;
a sub-cycle transfer switch comprising a first input powered from the output of said first sag ride thru device, a second input powered from the output of said second sag ride thru device, and an output powered from one of said first and second inputs; and
at least one transformer including an input powered from the output of said sub-cycle transfer switch and an output structured to power a number of ultraviolet lights.

23. A power system for ultraviolet lighting, said power system comprising:
a first sag ride thru device including an input structured to receive a first power source and an output;
a second sag ride thru device including an input structured to receive a second power source and an output;
a first transformer powered from the output of said first sag ride thru device, said first transformer outputting a first output;
a second transformer powered from the output of said second sag ride thru device, said second transformer outputting a second output;
a first circuit interrupter inputting the first output of said first transformer and outputting a third output;
a second circuit interrupter inputting the second output of said second transformer and outputting a fourth output; and
a normally open tie circuit interrupter electrically connected between the third output of said first circuit interrupter and the fourth output of said second circuit interrupter,
wherein the third output of said first circuit interrupter is structured to power a number of ultraviolet lights, and
wherein the fourth output of said second circuit interrupter is structured to power a number of ultraviolet lights.

24. A power system for ultraviolet lighting, said power system comprising:
a first transformer structured to be powered from a first power source and to output a first output;
a second transformer structured to be powered from a second power source and to output a second output;
a first circuit interrupter inputting the first output of said first transformer and outputting a third output;
a second circuit interrupter inputting the second output of said second transformer and outputting a fourth output;
a normally open tie circuit interrupter electrically connected between the third output of said first circuit interrupter and the fourth output of said second circuit interrupter;
a first sag ride thru device including an input powered from the third output of said first circuit interrupter and an output structured to power a number of ultraviolet lights; and
a second sag ride thru device including an input powered from the fourth output of said second circuit interrupter and an output structured to power a number of ultraviolet lights.

25. A low voltage power system for ultraviolet lighting, said power system comprising:
a first normally closed circuit interrupter structured to receive a low voltage power source and output a first output responsive to predetermined voltage and forward power flow conditions;
a second normally closed circuit interrupter structured to receive a low voltage power source and output a second output responsive to predetermined voltage and forward power flow conditions;
a tie circuit interrupter electrically connected between the first output of said first circuit interrupter and the second output of said second circuit interrupter; and
at least one sag ride thru device including an input powered from one or both of said first and second outputs and an output structured to power a number of ultraviolet lights.
